(19) United States
(12) Patent Application Publication
(10) Pub. No.: US 2010/0313924 A1
(43) Pub. Date: Dec. 16, 2010

(54) WALKER

(76) Inventor: SANG DEOG CHO, SEOUL (KR)

Correspondence Address: MAXON IP LLC, 46175 WESTLAKE DR., SUITE 410, POTOMAC FALLS, VA, 20165, US

(21) Appl. No.: 12/791,835

(22) Filed: Jun. 1, 2010

(30) Foreign Application Priority Data
Jun. 15, 2009 (KR) 10-2009-0052884
Mar. 24, 2010 (KR) 10-2010-0026209

(51) Int. Cl. A61H 3/04; A45B 9/00

(52) U.S. Cl. 135/66; 135/67; 135/85; 135/74

(57) ABSTRACT

A folding walker is formed in an X-shaped rear body having a pair of tubular frames. The frames are pivotally mounted on a pivot joint. Wheels are attached to the lower end of the body. A front leg is hingedly connected to the pivot joint so that the front leg is collapsible toward the legs and forms a tripod with the rear legs. Handle structures are adjustable to a desired height and angle. A brace is for locking the walker into unfolded position and unlocking the walker into folded position. A brake system shows that applying either of brake levers attached on the handle or both enables the brake shoes onto the wheels simultaneously.

### CROSS-REFERENCE TO RELATED APPLICATIONS

This application claims the benefit foreign priority of Korean Application No. 10-2009-0052884 filed Jun. 15, 2009 and Korean Application No. 10-2010-0026209 filed Mar. 24, 2010, which are incorporated herein in its entirety.

### BACKGROUND OF THE INVENTION

The present invention generally relates to walkers. More particularly, this invention relates to foldable tripod walkers with wheels.

Various foldable walkers with wheels have been introduced for people who are temporarily or permanently disabled and who may have difficulty walking unaided. The purpose of a walker is to provide support, help maintain balance, and prevent a fall when in motion.

Most walkers are placed in front of a user and pushed while the user is walking. Most commonly available walkers are four-legged with or without wheels. There are also some foldable three-legged walkers. The three-legged walkers have the advantages of easier maneuverability particularly around smaller space, and compact design for better storage.

However, the existing three legged walkers have some limitations and inconvenient features. While not intending to promote any particular interpretation, it appears that one of limitation is in its linear frame. Because of its linear frame, hand position of handle bar is not leveled and located over the middle of the walker so the user needs to lean forward in uncomfortable and unstable position.

They also lack effective braking system that could used in emergent situations. Ones that do have the brake, the wires are exposed therefore visually not pleasing nor have the ability to hold storage bags.

The present invention addresses these limitations using a pair of rear wheel body pivotally connected in X-shape with its upper frame extending upwardly and rearwardly into more comfortable position toward the user, and the lower frame extending downwardly and rearwardly to form a stable tripod when connected hingedly with the front leg.

Additionally, the grip bar is in C and reverse C shape to allow flexible hand positions. The grip frame is attached to the upper frame portion in a way that its rotatable to a desired angle and adjustable to a desired height.

Furthermore, brake lever attached to the grip frame is connected with brake wire to the rear wheels operatively so that either brake lever can apply brakes on both rear wheels to stop in case of emergency and maintain the brake in on position for safety. Brake wires are concealed inside the frame so that it is visually appealing but also safer in that the user can not get caught on the concealed wires.

### SUMMARY OF THE INVENTION

The first embodiment of the invention provides a folding walker for having an X-shaped vertical body having a pair of tubular frames. The frames are pivotally mounted on a pivot joint like a plier so as to fold or unfold the frames around the pivot joint. The upper frame portions upwardly separating from the pivot joint are defined as arms and the lower frame portions downwardly separating from the pivot joint are defined as rear legs.

In addition to the rear legs, a front leg is formed in a tubular frame wherein the upper end of the front leg is hingedly connected to the pivot joint so that the front leg is collapsible toward the rear legs when in folded position, and wherein the front leg and the pair of rear legs form a tripod when in unfolded position.

Lastly, brace members has a set of three rods wherein each end of the rods are hingedly connected to the front and the real legs while the other ends of the rods are hingedly connected to a rod joint for locking the walker into unfolded position and unlocking the walker into folded position.

The second embodiment of the invention provides a folding walker for having an X-shaped vertical body having a pair of tubular frames. The frames are pivotally mounted on a pivot joint like a plier so as to fold or unfold the frames around the pivot joint. The upper frame portions upwardly separating from the pivot joint are defined as arms and lower frame portions downwardly separating from the pivot joint are defined as rear legs.

In addition to the rear legs, a front leg formed in a tubular frame wherein the upper end of the frame is hingedly connected to the pivot joint so that the front leg is collapsible toward the legs when in folded position, and wherein the front leg and the pair of rear legs form a tripod when in unfolded position.

Handle members comprises a pair of handle stems and a pair of handle grips. One end of the handle stems is attached on the upper end of the arms, and other end of the handle grip is attached to the upper end of the handle stems.

Lastly, brace members have a set of three rods. Each end of the rods is hingedly connected to the legs while the other ends of the rods are hingedly connected to a rod joint for locking the walker into unfolded position and unlocking the walker into folded position.

The third and preferred embodiment of the invention provides a folding walker for having an X-shaped vertical body having a pair of tubular frames. The frames are pivotally mounted on a pivot joint like a plier so as to fold or unfold the frames around the pivot joint. The upper frame portions upwardly separating from the pivot joint are defined as arms and the lower frame portions downwardly separating from the pivot joint are defined as rear legs. A pair of wheel covers and a pair of traction wheels are attached to the lower end of the legs.

Secondly, a front leg is formed in a tubular frame wherein the upper end of the frame is hingedly connected to the pivot joint so that the front leg is collapsible toward the legs. The front leg and the pair of rear legs form a tripod from the pivot joint when in unfolded position.

Third, handle members include a pair of handle stems and a pair of handle grips. One end of the supports is attached on the upper end of the arms, and other end of the grip is attached to the upper end of the handle stems.

Fourth, brace members include a set of three rods wherein each end of the rods are hingedly connected to the legs while the other ends of the rods are hingedly connected to a rod joint for locking the walker into unfolded position and unlocking the walker into folded position.

Finally, brake members have a pair of brake levers, a pair of brake shoes, and a link loop rotatably mounted on the pivot joint. A first set of brake wires are operatively connected between the brake levers and the upper portion of the link loop. A second set of brake wires are operatively connected between the brake shoes and the lower portions of the link loop. Pulling the first set of wires by applying either of the brake levers or both enables the link loop to turn thereby pulling the second set of wires so as to apply both brake shoes onto the wheels simultaneously.

Other objects and advantages of this invention will be better appreciated from the following detailed description.

### BRIEF DESCRIPTION OF THE DRAWINGS

FIG. 1 shows a perspective view of a folding walker in accordance with a preferred embodiment of the invention.

FIG. 2 shows the folding walker in an exploded view.

FIG. 3a shows handle structures of the folding walker.

FIG. 3b shows an exploded view of the handle portion of the folding walker.

FIG. 3c-3f shows that a grip frame is rotatable inside a handle stem head so that the handle grip frame is adjustable to a desired angle.

FIG. 3g shows a cross-sectional view of handle stem head.

FIG. 4a shows a rear-wheel having a rear-wheel cover that covers the top and the center of the wheel.

FIG. 4b shows a brake wire which operates inside the rear-wheel cover.

FIG. 4c shows the rear-wheel members in an exploded view.

FIG. 4d shows a connection between a brake shoe and the brake wire which operates inside the rear-wheel cover in accordance with the preferred embodiment of the invention.

FIG. 5a shows that front-wheel members consist of wheel axis support and a set of front-wheels.

FIG. 5b shows the front-wheel portion in an exploded view.

FIG. 5c shows a cross-sectional view of the front-wheel members.

FIG. 6a shows that a brace joint is turning and lifting upward to unlock a brace rods allowing the walker to fold.

FIG. 6b shows an exploded view of the brace joint members consisting of a brace joint handle, a brace joint controller, and a rod joint member.

FIGS. 6c and 6f shows a set of hinge pins connected to the corresponding rods.

FIG. 6d shows a brace joint key at the end of hinge ring interlocking with the brace joint key notch of the brace joint controller.

FIG. 6e shows the brace joint controller with a brace joint key notch that controls locking and releasing of the rods.

FIG. 7a shows an attached storage bag that can be attached to a pivot joint portion and the lower frames.

FIG. 7b shows a side-hook opened in detail with a hinge joint, a frame lock and a hook.

FIG. 7c shows a pivot joint portion having a protruded portion that fits into the pivot joint rings of both upper and lower frames of the rear-wheel body and the upper end of the front-wheel body.

FIG. 7d shows a link loop located inside the pivot joint portion where an upper set of the brake wires and the lower set of wires are attached to the link loop.

FIG. 7e shows the pivot joint portion in an exploded view.

FIG. 7f shows the brake wires installed inside the pivot joint portion through the pair of pivot joint rings.

FIG. 8a shows a front view of the folding walker in a folded state in accordance with a preferred embodiment of the invention.

FIG. 8b shows a side view of the folding walker in a folded state in accordance with a preferred embodiment of the invention.

FIG. 9a shows a perspective view of the folding walker in an unfolded state in accordance with a preferred embodiment of the invention.

FIG. 9b shows a side view of the folding walker in an unfolded state in accordance with a preferred embodiment of the invention.

FIG. 9c shows a front view of the folding walker in an unfolded state in accordance with a preferred embodiment of the invention.

FIG. 9d shows a top view of the folding walker in an unfolded state in accordance with a preferred embodiment of the invention.

FIG. 10a shows a perspective view of the folding walker in a folded state in accordance with a preferred embodiment of the invention.

FIG. 10b shows a side view of the folding walker in a folded state in accordance with a preferred embodiment of the invention.

FIG. 10c shows a front view of the folding walker in a folded state in accordance with a preferred embodiment of the invention.

FIG. 10d shows a top view of the folding walker in a folded state in accordance with a preferred embodiment of the invention.

### DETAILED DESCRIPTION OF THE INVENTION

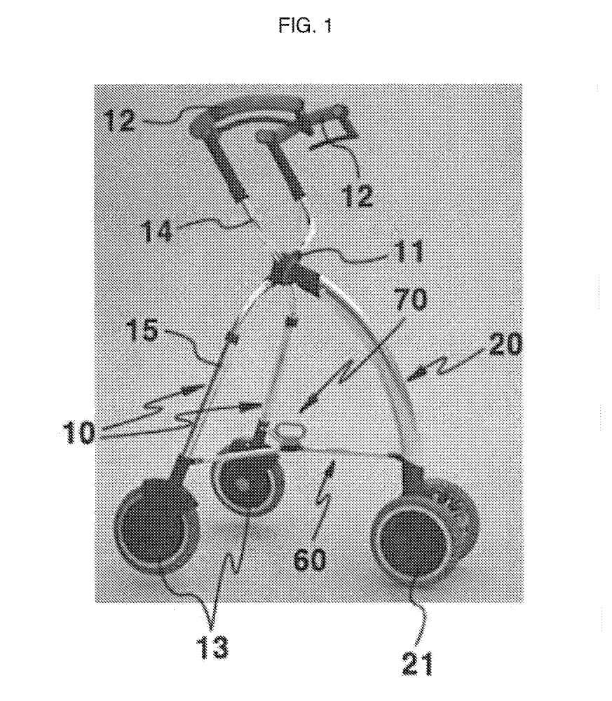

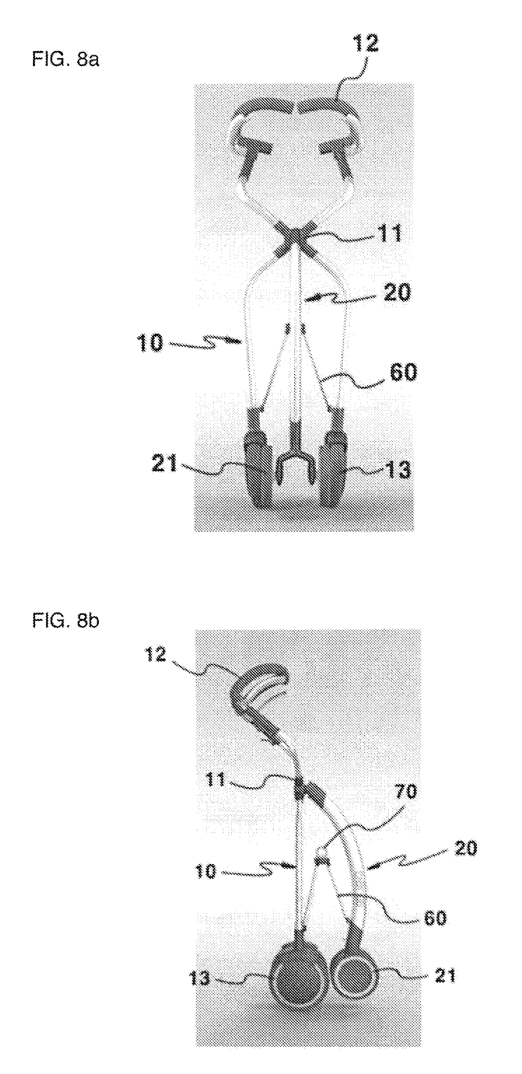

As shown in FIG. 1 and FIG. 8b, the folding walker comprises a rear-wheel body 10 and a front-wheel-body 20. The rear-wheel body 10 has a symmetric structure (such as X-shape), so that the rear wheel-body 10 can be folded or unfolded at a pivot joint portion 11. The real-wheel body 10 further comprises a pair of handles 12 at its upper portion and a pair of rear-wheels 13 at its lower portion of the body 10. The upper portion of the front-wheel body 20 is hingedly connected to the pivot portion 11, and the lower portion of the front-wheel body 20 has a set of the front-wheels 21.

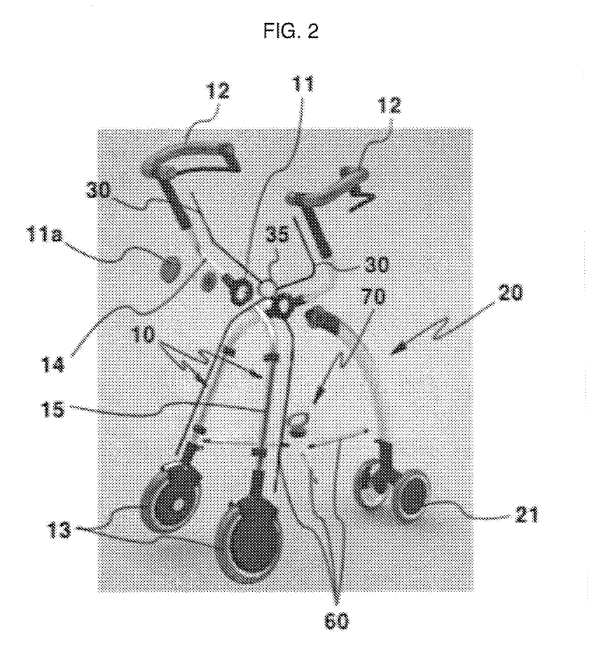

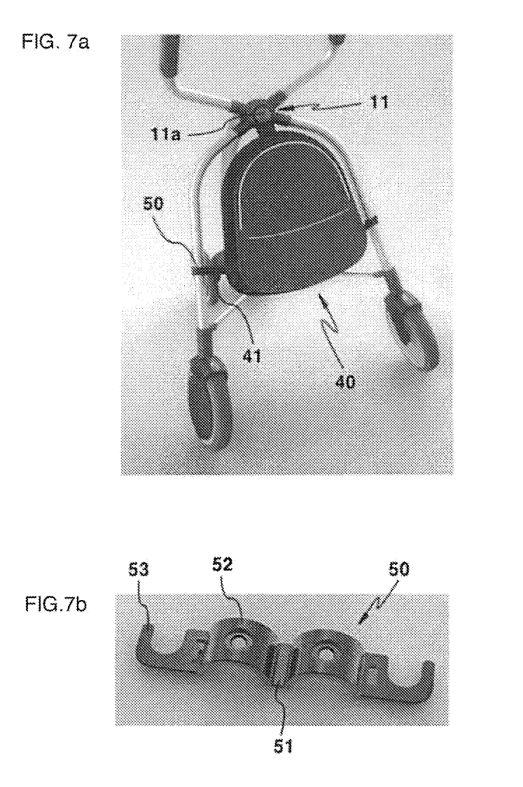

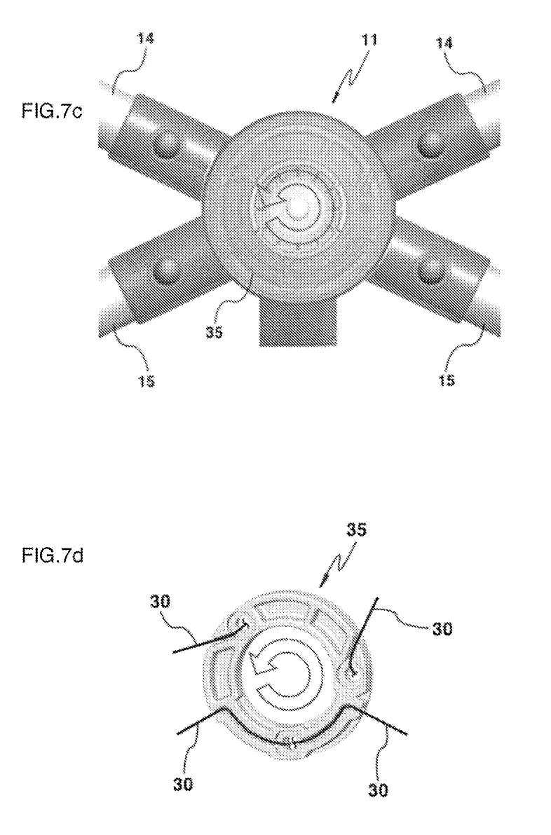

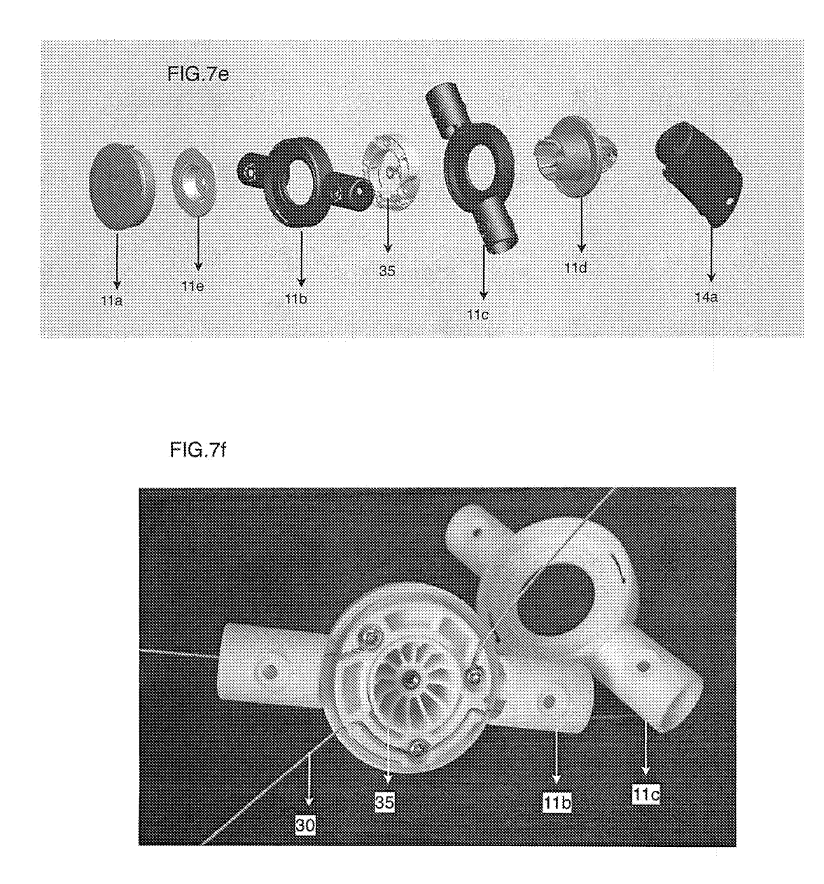

The rear-wheel body 10 as shown in FIG. 2 consists of two tubular type frames 14, 15. Further, each frame can be divided into an upper frame 14 and a lower frame 15. A pair of pivot joint rings 11b, 11c is configured to connect the upper frame 14 and the lower frame 15 make each side of the rear-wheel body 10. Then, each assembled frames (i.e., right assembled frame and left assembled frame) is pivotally connected at the pivot joint portion 11 in X-shape like a scissor. Also, the front-wheel body 20 is hingedly connected to the pivot joint portion 11 together, so that it can fold into the rear-wheel body 10. Like a pin, a pivot joint portion 11 has a protruded portion 11a that fits into the pivot joint rings 11a, 11b of both upper and lower frames of the rear-wheel body 10 and the upper end of the front-wheel body 20 as shown in FIG. 7c.

The two frames of the real-wheel body 10 are placed in X-shape where the upper portion 14 of the frame extends up diagonally from the pivot joint portion 11 then bends upward towards the handle 12a while the lower portion 15 extends down diagonally then bending downward toward the rear-wheels 13.

When viewed from the side, the upper portion 14 of the frame of the rear-wheel body 10 extends upwardly from the pivot joint portion 11 then bends backward towards the user while the lower portion 15 of the frame extends downwardly from the pivot joint portion 11 then bends backward toward a user of the folding walker. The front-wheel body 20 extends down forwardly from the pivot joint portion 11 toward the front wheels 21. As a whole, the lower portions with the rear-wheel-body 10 and the front-wheel-body 20 form a stable tripod as shown in FIGS. 1-2.

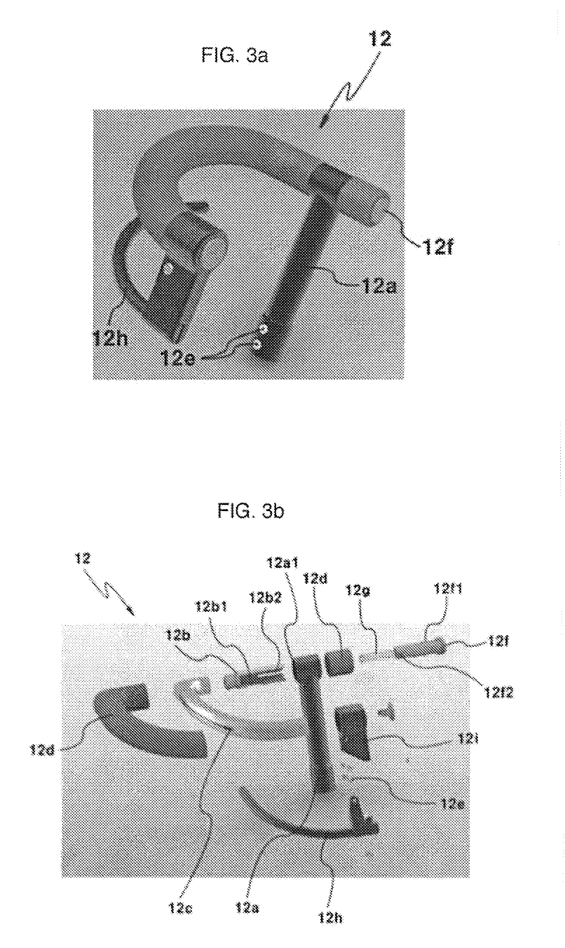

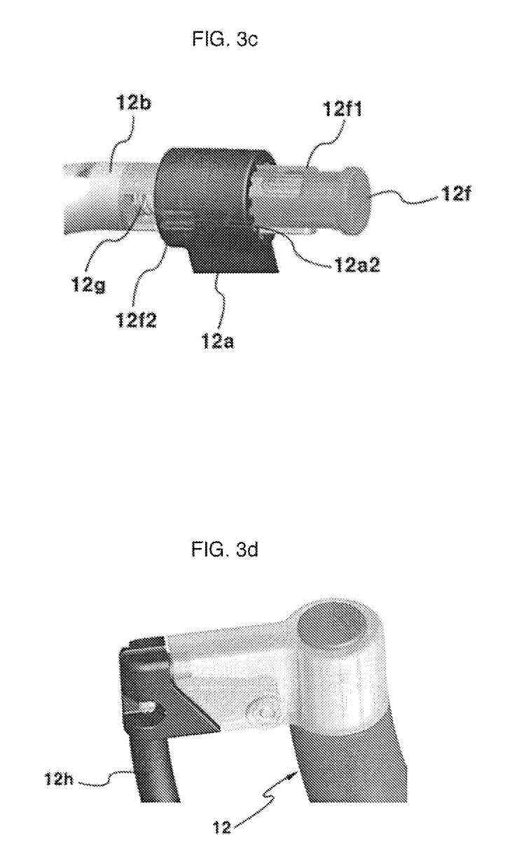

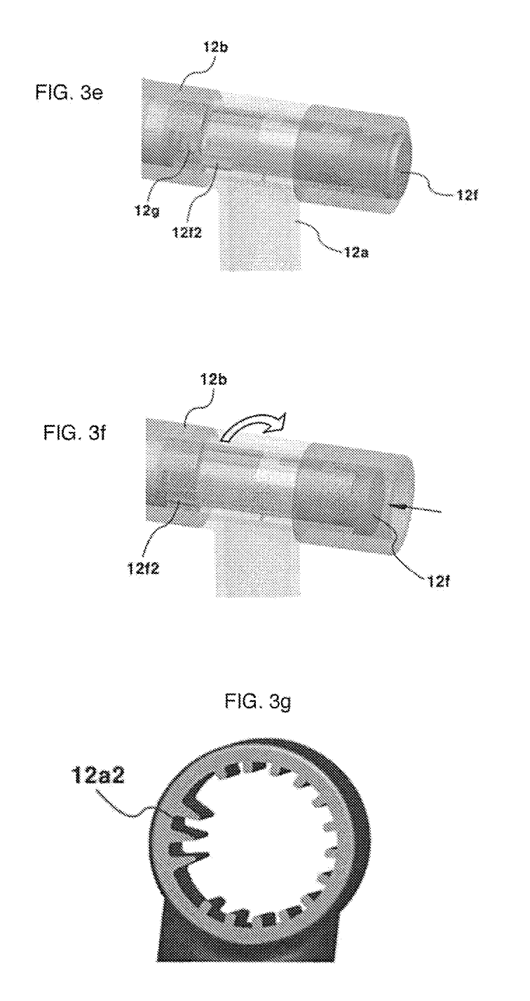

FIGS. 3a & 3b shows the handle portion 12 in more detail. Handle portion 12 can be divided into a handle stem 12a, a grip frame 12c, a grip connector 12b and grip angle button 12f. Upper portion of frame 14 is inserted into a lower end of handle support 12a. The grip connector 12b is inserted into the handle stem head 12a1, and the grip frame 12c is fitted over the outer portion of grip connector 12b.

Like a telescopic body, the connector 12a is configured to fit over with the end of the upper portion of frame 14 so that a pair of height adjuster pins 12e can control the height of the frame 14.

Again, the upper portion of upper frame 14 is inserted into the lower portion of handle stem 12a, and fixed with by passing the height adjuster pins 12e through the holes at the lower end of handle stem 12a3 thereby connecting the upper frame 14 and handle portion 12 into one body while maintaining the adjusted height.

FIGS. 3c-3f show that the grip frame 12c is configured to be rotatable inside the handle stem head 12a1 so that the handle grip frame 12b is adjustable to a desired angle as demonstrated in FIG. 3f.

FIG. 3g shows a cross-sectional view of the handle stem head 12a1. Inside of the handle stem head 12a1 is lined with multiple wedge-shaped threads named grip angle internal tooth 12a2 that operatively interlocks against the grip angle external tooth 12f2 when the grip angle button 12f is depressed thereby holding the grip frame 12c at a desired angle as shown in FIG. 3c-3f.

FIG. 3a shows the grip frame 12c is shaped like letter C extending from the handle stem head 12a1 and bending inward in the shaped of letter C.

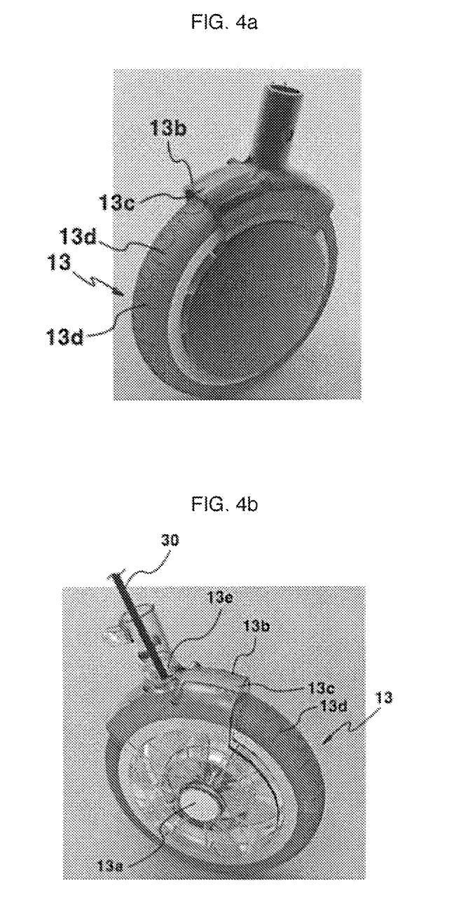

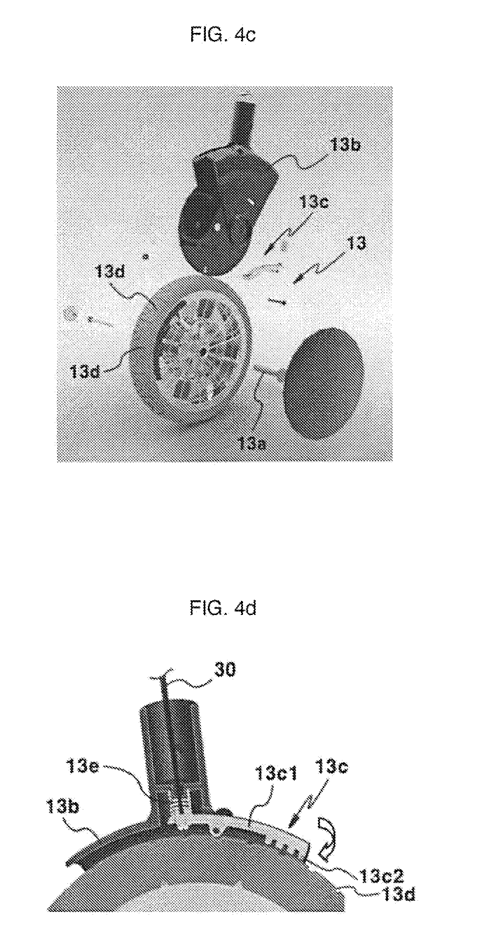

FIG. 4a shows a rear-wheel 13 that is connected to the lower frame 15 and a rear-wheel cover 13b that covers the top and the center portion of the wheel 13.

FIG. 4d shows a brake shoe 13c under the wheel cover 13b. The brake shoe 13c1 is connected to a brake wire 30 that operatively extends from the break lever 12h so that the brake shoe 13c applied onto the wheel 13 when the brake lever 12h pulls on the brake wire 30.

FIG. 3a and FIG. 4b shows a brake lever bracket 12i attached to the end of the grip frame 12c and the brake lever 12h is hingedly connected to brake lever bracket 12i so that when brake lever 12h is applied, it operatively pulls up on the brake wire 30.

It is also possible to add a holding mechanism that keeps the brake lever 12h at its place thereby maintaining the brake in its position.

As shown in FIG. 4d, the brake 13c curves and extends along to the surface of the wheel and has multiple brake shoe teeth 13c2 so when the brake wire 30 attached to the brake 13c is pulled, brake shoe teeth 13c2 interlocks onto tire thread 13d.

FIG. 4d also shows a return spring 13e inside the wheel cover 13b. The spring 13e returns the brake shoe 13 to initial position once the pressure on the brake lever 12h has ceased.

In addition, the frames of the brake lever bracket 12i, the grip frame 12c, the handle stem 12a, the upper frame 14, the lower frame 15 and the wheel cover 13b are all hollow to allow the brake wire 30 to be concealed inside all the frames and relevant parts.

FIG. 2 and FIG. 7d show a link loop 35 located inside the pivot joint portion 11. An upper set of the brake wires 30 extends from the brake lever 12h through the grip frame 12c and the handle stem 12a then attaches to the upper portion of the link loop 35 as shown in FIG. 7d. A lower set of the brake wires 30 attaches to the brakes shoe 13c and extends upward through the lower frame 15 and attaches to the lower portion of the link loop 35. When either one of the brake levers 12h is used, it pulls on one of the upper brake wires 30 and rotates the link loop 35. When the link loop 35 rotates, it pulls on both lower brake wires simultaneously thereby operatively apply brakes on both traction wheels 13.

The brake wires 30 are fixed to the link loop 35 by passed through each corresponding holes as shown in FIG. 7d and are fixed on the other side of the loop link 35.

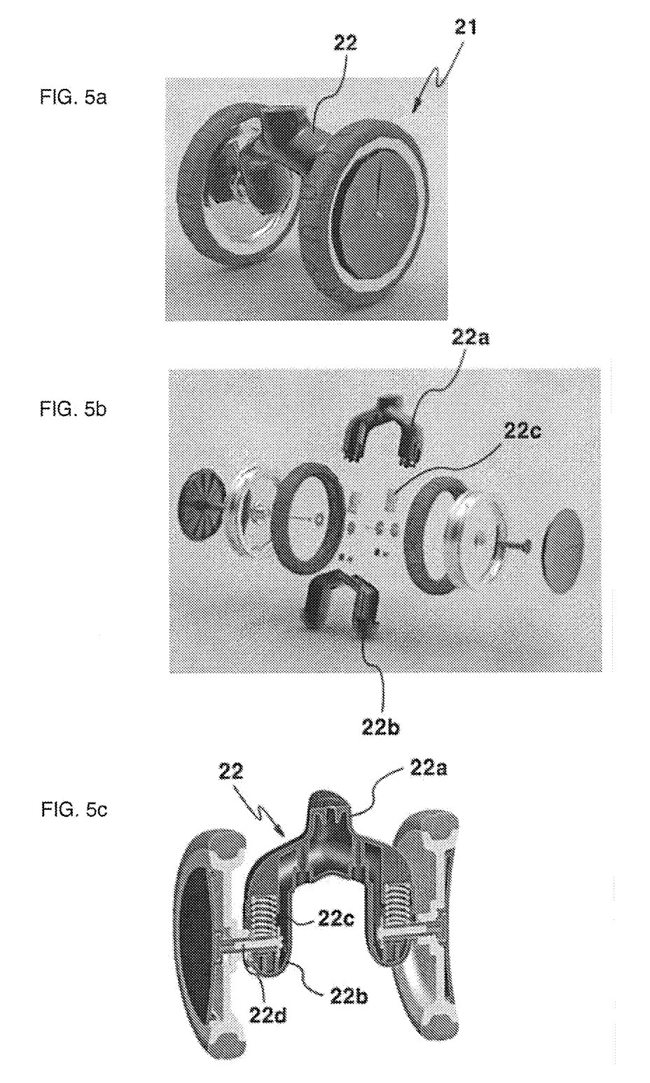

FIG. 5a shows the front-wheel members consists of wheel axis support 22 and a set of front-wheels 21. The distal end of the front wheel body 20 is inserted into upper portion of the wheel axis support 22.

FIG. 5b shows the front-wheel portion in the exploded view. The wheel axis support 22 consists of an upper body 22a and a lower body 22b. A spring 22c is located inside the axis support 22 as shock absorber as shown in FIG. 5c.

FIG. 5c shows a cross-sectional view of the front-wheel portion. A wheel axis plate 22d supports the spring 22c.

FIG. 7a shows an attached storage bag 40. The bag can be attached to the pivot joint portion 11 and the lower frames 15.

FIG. 7b shows a side-hook 50 opened in detail with a hinge joint 51, a frame lock 52 and a hook 53. The side-hook 50 can be closed around the lower frame 15.

Next, a foldable brace will be described. As shown in FIG. 1, the foldable brace consists of a set of three rods 60 hingedly connected to the lower frames 15 and the front-wheel body 20 in unfolded state, and a brace joint 70 that hingedly joins the three rods 60 together.

The three rods 60 are hingedly joined by the brace joint 70 so that the walker can be folded as shown in FIGS. 8a & 8b. When the walker is unfolded as shown in FIG. 1, the foldable brace supports the lower frames 15 and the front-wheel body 20, and maintains the walker locked in an unfolded state.

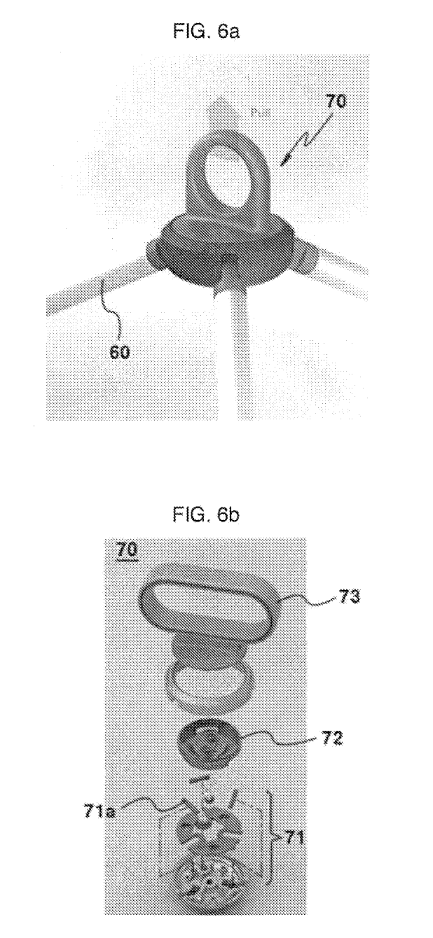

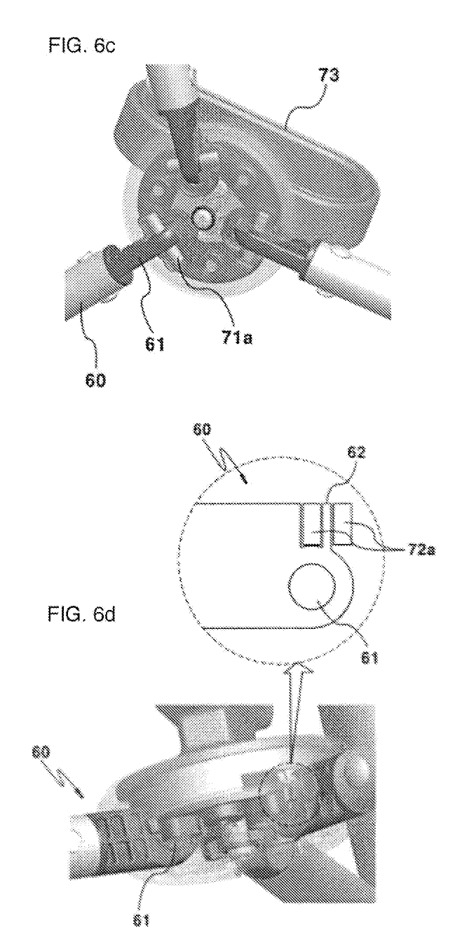

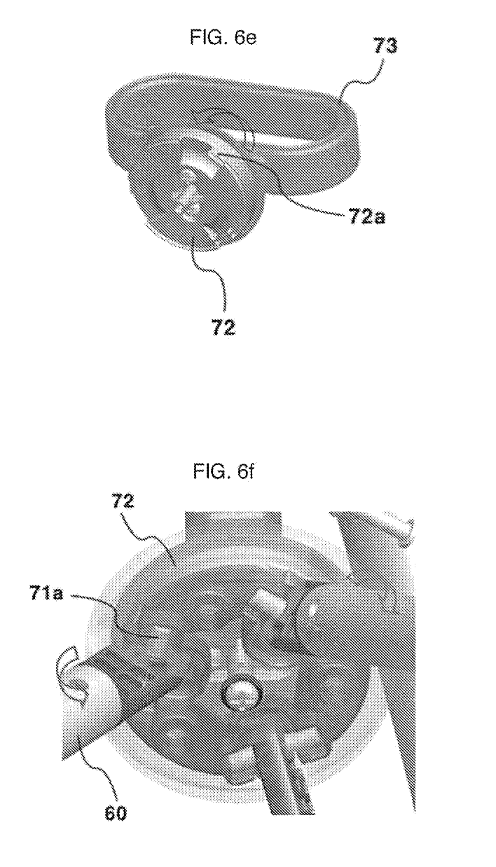

FIG. 6b is an exploded view of the brace joint members 70 consists of a brace joint handle 73, a brace joint controller 72 and a rod joint member 71. As shown in FIG. 6a, the brace joint 70 can turn and lift upward to unlock the brace rods 60 allowing the walker to fold. When the walker is unfolded, the brace joint 70 can be turned and locked so that the rods 60 spread out and support the lower frames 15 and the front-wheel body 20 in a stable tripod position. A hinge pin 71a hingedly connects the rods 60 to rod joint 71 as shown in FIG. 6c. In addition, FIG. 6e shows the brace joint controller 72 with a brace joint key notch 72 that controls locking and releasing of the rods 60. FIGS. 6b and 6c show the brace joint handle 73 on top of the brace controller 72 and a set of three hinge rings 61. A hinge pin 71a hingedly connects the three rods 60 to the rod joint 71 as shown in FIG. 6c. Lastly, FIG. 6d shows a brace joint key 62 at the end of hinge ring 61 interlocking with the brace joint key notch of the brace joint controller 72.

Followings are the assembly processes of the folding walker. First, handles 12 are attached to the tops of the rear-wheel body 10 and the real wheels 13 are attached to the bottoms of the rear-wheel body 10. A set of front wheels 21 are attached to the bottom of front-wheel body 20. Then, the pivot rings 11b, 11c of each rear-wheel body 10 are laid on top of one another to form an X shape and connected with the pivot joint cap 11a, the pivot joint rings 11b, 11c, and the upper portion of the front body 20.

Then, rod brace 60 is hingedly attached to the lower frames 15 of the rear-wheel body 10 and to the lower portion of the front body (front leg) 20. The three rods of the rod brace 60 are joined in the middle by the brace joint 70.

Lastly, the brake levers 12h are installed on the outer end of the grip frame 12c, and the brake wire 30 extends from the brake levers 12h along the rear-wheel body 10 and attaches to the brakes shoes 13c at the rear wheels 13 as shown in FIG. 2, FIG. 4d, and FIG. 7d.

The completed foldable walker can now be opened using the rod brace 60 to spread out the legs and hold them in position as seen in FIG. 1.

Then, the rod brace 60 is locked with the brace joint 70 maintaining in open position allowing the user to operate it safely.

A user can now grab the handle 12 anywhere along the grip frame 12c and operate the brake shoe 13c while pushing the walker forward.

Hence, when a user walks with the walker and sees an obstacle the user can easily manipulate around the obstacle or stop using either one of the brake levers 12h.

When either one of the brake lever 12h is used, it pulls on the brake wire 30, and the brake shoe 13c is applied as the brake shoe teeth 13c2 wedges into the rear-wheel tire tread 13d as shown in FIG. 4d. In addition, it may be possible to hold the brake wire 30 in brake position using an on-hold button mechanism.

A user can undo the brake by releasing the on-hold button when ready to continue walking again.

If a user finds the hand grip position uncomfortable, user can adjust the angle of the grip frame 12c by pressing on the grip angle button 12f as shown in FIG. 3c. When the grip angle button 12f is depressed, the grip angle external tooth 12f2 is released from the grip angle internal tooth 12a2 of the handle stem head 12a1 allowing the grip frame 12c to be rotated. While keeping the grip angle button 12f depressed, the grip frame 12c is adjusted to a desired angle, and then the grip angle button 12f is released allowing the grip angle external tooth 12f2 and the grip angle internal tooth 12a2 to interlock again.

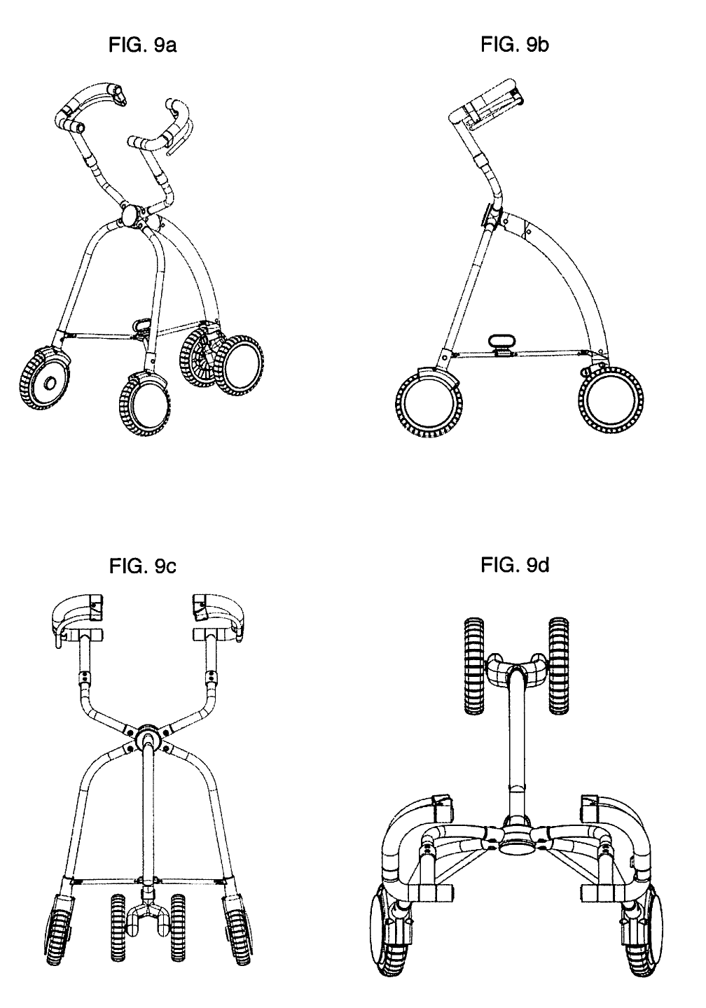

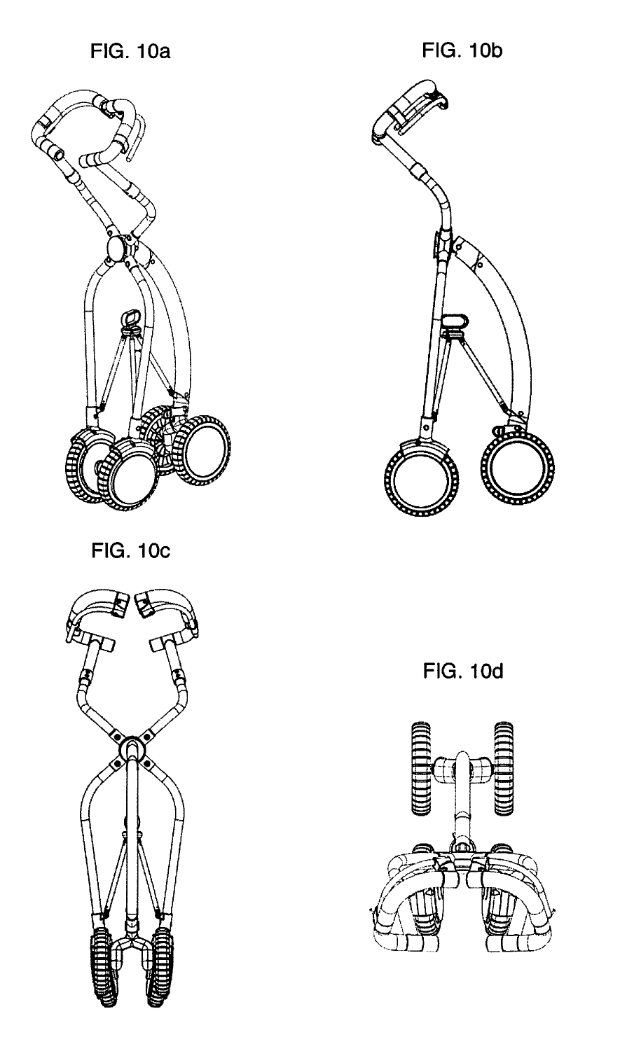

When the walker needs to be folded for easier storage, the brace joint handle 73 is first rotated to release the brace joint key 62 from the brace joint key notch 72a. Then the brace joint handle 73 is lifted pulling together the two lower frames 15 and the front body (front leg) 20 upward towards the pivot joint 11 thereby folding the walker as shown in FIGS. 8 and 9.

When the walker needs to be unfolded for use, the rear-wheel-body 10 and the front leg 20 can be opened in opposing direction by pressing down on the rod brace 60 using the brace joint handle 73. Then the brace joint handle 73 is rotated which turns the brace joint controller 72 allowing the brace joint key 62 to insert into the brace joint key notch 72a locking the walker in the unfolded state and ready for use.

While the invention has been described in terms of preferred embodiments, it is apparent that other forms could be adopted by one skilled in the art.

1. A folding walker comprising:
a. An X-shaped vertical body having a pair of tubular frames, wherein the frames are pivotally mounted on a pivot joint like a plier so as to fold or unfold the frames around the pivot joint, wherein the upper frame portions upwardly separating from the pivot joint are defined as arms and the lower frame portions downwardly separating from the pivot joint are defined as rear legs, and wherein the upper end of the arm are curved to form a handle;
b. A front leg formed in a tubular frame wherein the upper end of the front leg is hingedly connected to the pivot joint so that the front leg is collapsible toward the rear legs when in folded position, and wherein the front leg and the pair of rear legs form a tripod when in unfolded position;
c. Brace members having a set of three rods wherein each end of the rods are hingedly connected to the front and the real legs while the other end of the rods are hingedly connected to a rod joint for locking the walker into unfolded position and unlocking the walker into folded position.

2. The folding walker according to claim 1, further comprising a pair of traction wheels wherein the wheels are attached at the lower ends of the rear legs.

3. The folding walker according to claim 1, further comprising a set of traction wheels wherein the set is attached at the lower end of the front leg.

4. The folding walker according to claim 1, wherein the handle is shaped like letter C so that a user can grab at any desired portion along the handle.

5. The folding walker according to claim 1, wherein the arms are projecting rearwardly and inwardly from the pivot joint toward the user.

6. The folding walker according to claim 1, further comprising a bag wherein the bag is attachable on the body.

7. A folding walker comprising:
a. An X-shaped vertical body having a pair of tubular frames wherein the frames are pivotally mounted on a pivot joint like a plier so as to fold or unfold the frames around the pivot joint and wherein upper frame portions upwardly separating from the pivot joint are defined as arms and lower frame portions downwardly separating from the pivot joint are defined as rear legs;
b. A front leg formed in a tubular frame wherein the upper end of the frame is hingedly connected to the pivot joint so that the front leg is collapsible toward the legs when in folded position, and wherein the front leg and the pair of rear legs form a tripod when in unfolded position;
c. Handle members comprising a pair of handle stems and a pair of handle grips wherein one end of the handle stems is attached on the upper end of the arm, and wherein one end of the handle grip is attached to the upper end of the handle stems;
d. Brace members having a set of three rods wherein the each end of the rods are hingedly connected to the legs while the other ends of the rods are hingedly connected to a rod joint for locking the walker into unfolded position and unlocking the walker into folded position.

8. The folding walker according to claim 7, further comprising a pair of traction wheels wherein the wheels are attached at the lower ends of the rear legs.

9. The folding walker according to claim 7, further comprising a set of traction wheels wherein the set is attached at the lower end of the front leg.

10. The folding walker according to claim 7, wherein the handle stems are adjustable to a desired height along the arms and are rotatable along the axis of the arms.

11. The folding walker according to claim 7, wherein the handle grips are adjustable to a desired angle where the handle grips attach to the upper ends of the handle stems.

12. The folding walker according to claim 7, wherein the handle grips are shaped like letter C so that a user can grab at any desired portion along the grips.

13. The folding walker according to claim 7, wherein the arms are projecting rearwardly and inwardly from the pivot joint toward the user.

14. The folding walker according to claim 7, further comprising a bag wherein the bag is attachable on the body.

15. A folding walker comprising:
a. An X-shaped vertical body having a pair of tubular frames, wherein the frames are pivotally mounted on a pivot joint like a plier so as to fold or unfold the frames around the pivot joint, wherein the upper frame portions upwardly separating from the pivot joint are defined as arms and the lower frame portions downwardly separating from the pivot joint are defined as rear legs, and wherein a pair of wheel covers and a pair of traction wheels are attached to the lower end of the legs;
b. A front leg formed in a tubular frame wherein the upper end of the frame is hingedly connected to the pivot joint so that the front leg is collapsible toward the legs and wherein the front leg and the pair of rear legs form a tripod from the pivot joint when in unfolded position;
c. Handle members comprising a pair of handle stems and a pair of handle grips wherein one end of the supports is attached on the upper end of the arm and wherein one end of the grip is attached to the upper end of the handle stems;
d. Brace members having a set of three rods wherein each end of the rods are hingedly connected to the legs while the other ends of the rods are hingedly connected to a rod joint for locking the walker into unfolded position and unlocking the walker into folded position; and
e. Brake members comprising a pair of brake levers attached to the handle grip, a pair of brake shoes attached to the wheel covers, a link loop rotatably mounted on the pivot joint, a first set of brake wires operatively connected between the brake levers and the upper portion of the link loop, and a second set of brake wires operatively connected between the brake shoes and the lower portions of the link loop, wherein pulling the first set of wires by applying either of the brake levers or both enables the link loop to turn thereby pulling the second set of wires so as to apply the brake shoes onto the wheels simultaneously.

16. The folding walker according to the claim 15, wherein the first and second sets of wires are internally inserted inside of the handle grip, the handle stems, the arms, the pivot joint, the rear legs, and the wheel covers to hide the wires.

17. The folding walker according to claim 15, further comprising a set of traction wheels wherein the set is attached at the lower end of the front leg.

18. The folding walker according to claim 15, wherein the handle stems are adjustable to a desired height along the arms and are rotatable along the axis of the arms.

19. The folding walker according to claim 15, wherein the handle grips are adjustable to a desired angle where the handle grips attach to the upper ends of the handle stems.

20. The folding walker according to claim 15, wherein the handle grips are shaped like letter C so that an user can grab at any desired portion along to the grips.

21. The folding walker according to claim 15, wherein the arms are projecting rearwardly and inwardly from the pivot joint toward the user.

22. The folding walker according to claim 15, further comprising a bag wherein the bag is attachable on the body.
